(19) United States
(12) Patent Application Publication
(10) Pub. No.: US 2025/0389213 A1
(43) Pub. Date: Dec. 25, 2025

(54) SMALL END BUSH LUBRICATION

(71) Applicant: Perkins Engines Company Limited, Peterborough (GB)

(72) Inventors: Saravanan Kumaresan, Chennai (IN); Paul Andrew Davies, Peterborough (GB)

(21) Appl. No.: 19/238,804

(22) Filed: Jun. 16, 2025

(30) Foreign Application Priority Data
Jun. 21, 2024 (GB) 2408975.7

(51) Int. Cl. F01M 11/02; F16C 33/10

(52) U.S. Cl. CPC F01M 11/02; F16C 33/1065; F01M 2011/026; F16C 2360/22

(57) ABSTRACT

A block carrier configured to provide lubrication to the small end bush in an internal combustion engine. The block carrier has a projection having an oil channel in fluid communication with an oil groove in an inner surface configured to receive a crankshaft main bearing and extending to a side surface of the projection. This provides a jet of lubricating oil which may be directed towards the small end of the connecting rod and the underside of the piston.

### CROSS REFERENCE TO RELATED APPLICATION(S)

This application claims priority to Great Britain Patent Application No. 2408975.7, filed Jun. 21, 2024, which is hereby incorporated by reference in its entirety.

### TECHNICAL FIELD

The present disclosure relates to a block carrier configured to provide lubrication to the small end bush in an internal combustion engine, and an internal combustion engine comprising such a block carrier.

### BACKGROUND

Engines, such as internal combustion engines, often include one or more reciprocating pistons each mounted in a cylinder in a cylinder block. The combustion of a mixture of air and fuel causes the pistons to move in response to the resulting rapid pressure and temperature rise in the cylinder. The pistons are connected to a rotatable crankshaft, by means of a connecting rod, to transform the reciprocating linear movement of the pistons into a rotational movement. Connecting rods generally have a big end, connected to a crank pin of the crankshaft, and a small end, connected to the piston by means of a gudgeon pin (also called a piston or wrist pin) which allows for rotation between the connecting rod and the piston. The gudgeon pin may be supported in a bush located in the small end bore to reduce friction between the gudgeon pin and the connecting rod by distributing the load over a larger area.

The cylinders and small end bushes may be splash lubricated by lubricating oil flung from the rotating components, for example from the crankshaft bearings. The shaft of the connecting rod may also be drilled to provide a lubrication passage extending from the big end to the small end to carry lubricating oil from the big end bearing to the small end. The external wall of the small end may also be drilled to provide lubrication passages into the small end bore. However, the small end bush may cover the ends of the lubrication passages, such that the lubricating oil does not flow to the inside of the bore. A lack of lubricant inside the small end bushes may lead to overheating and pitting of the small end bushes.

CN-A117449974 describes a cooling lubrication system for an engine, which has a complex arrangement of cooling nozzles and control valves with oil passages located around the cylinder block assembly.

### SUMMARY

According to the disclosure there is provided a block carrier for mounting a crankshaft in an engine block. The block carrier comprises an inner surface configured to receive a crankshaft main bearing and provided with at least one oil groove and a projection. The projection has at least one side surface, at least one first oil channel in fluid communication with the with the at least one oil groove and extending internally through the projection from the inner surface, and at least one second oil channel in fluid communication with the at least one first oil channel and extending internally from the at least one first oil channel to the at least one side surface terminating in an outlet in the at least one side surface.

According to the disclosure there is also provided an internal combustion engine comprising an engine block having at least one cylinder in which is reciprocally mounted a piston; at least one block carrier as described above; a crankshaft having a plurality of main journals on which are mounted in main bearings, said main bearings being mounted in the at least one block carrier; at least one connecting rod having a small end attached to the piston and a big end attached to the crankshaft; and means of supplying lubricating oil to the main bearings.

### BRIEF DESCRIPTION OF THE DRAWINGS

FIG. 1 is a perspective view of a cylinder block of an internal combustion engine according to the disclosure;

FIG. 2 is a cross section of part of an internal combustion engine including the cylinder block of FIG. 1, viewed along the line II-II, including a crankshaft sub-assembly mounted therein;

FIG. 3 is a perspective view of the crankshaft sub-assembly of FIG. 2;

FIG. 4 is a perspective view of a connecting rod;

FIG. 5 is a perspective view of a block carrier;

FIG. 6 is an enlarged cross section of a projection on an upper section of the block carrier;

### DETAILED DESCRIPTION

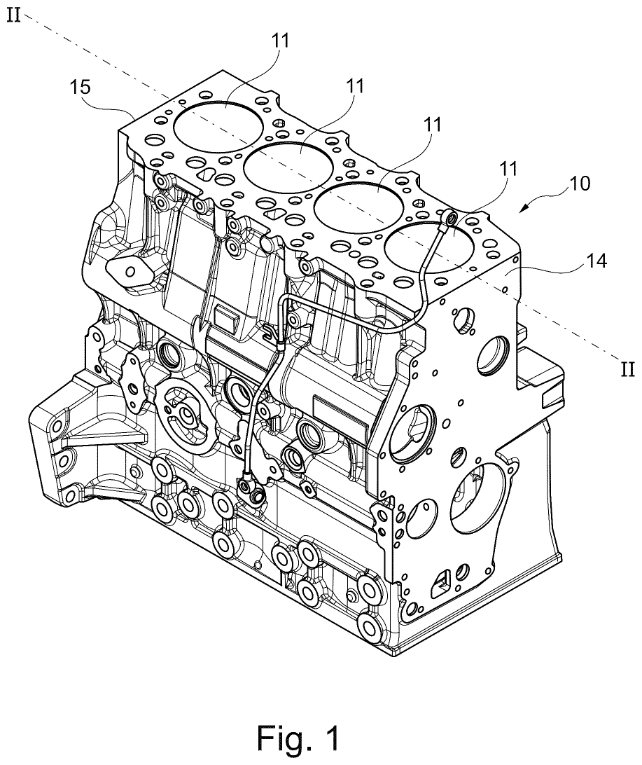

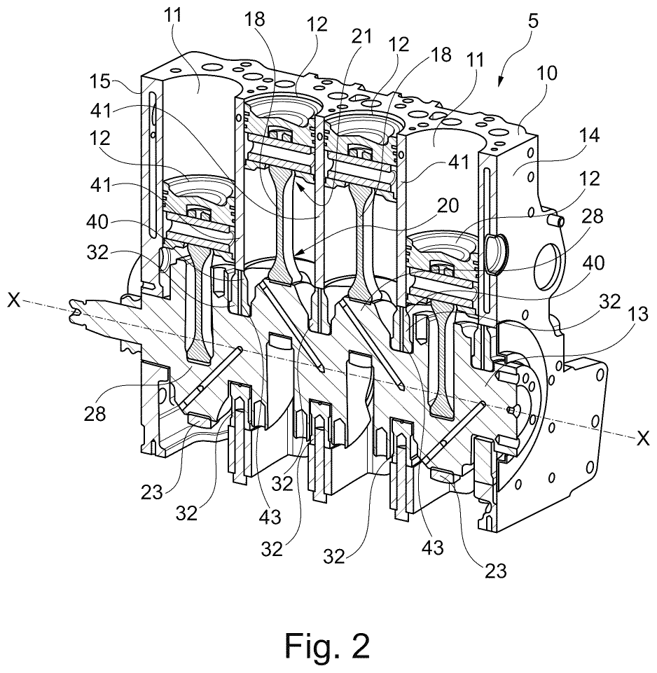

The present disclosure relates to an engine 5, which may include a cylinder block 10, as shown in FIGS. 1 and 2. The engine 5 may be an internal combustion engine configured to work on a compression ignition cycle. The engine 5 may be a diesel engine that may receive fuel, such as diesel fuel, for combustion and power generation. However, the engine 5 may use other fuels, such as gaseous fuels, including but not limited to propane gas, hydrogen gas, natural gas (methane), or other fuels, singularly or in combination with each other, or with the diesel fuel.

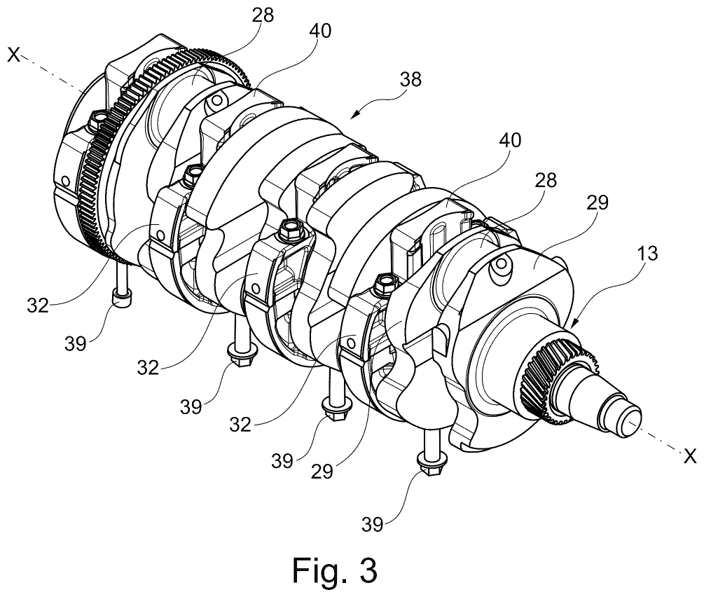

One or more cylinders 11 may be formed in the cylinder block 10, and a piston 12 may be slidably mounted within the or each cylinder 11 adapted to reciprocate between a top dead centre position and a bottom dead centre position within the cylinder 11. A crankshaft 13 (see FIGS. 2 and 3) may be rotatably mounted in the cylinder block 11 extending from a front block end 14 and the back block end 15. Each piston 12 may be coupled to the crankshaft 13 by a connecting rod 18. The crankshaft 13 may be rotatable about a crankshaft axis X-X and may be driven to rotate by the reciprocating action of the piston(s) 12.

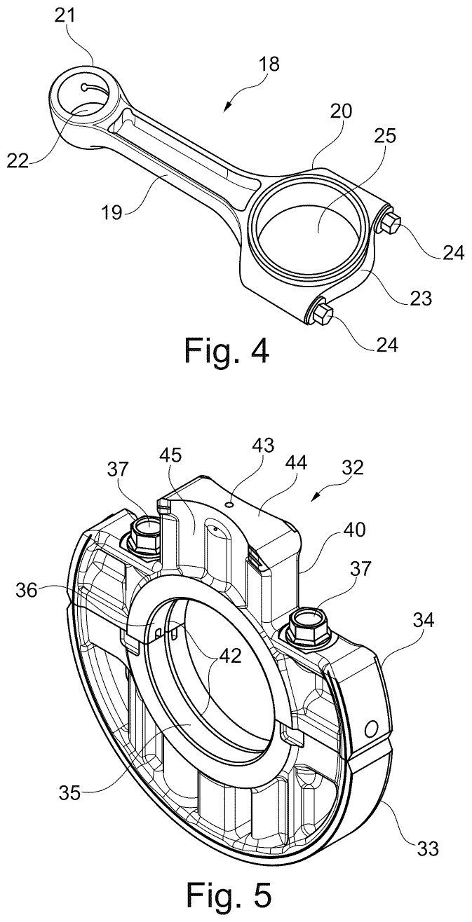

The connecting rod 18 (see FIG. 4) may have a big end 20 and a small end 21 separated by a shank 19. The small end 21 may define a small end bore 22. A small end bush (not shown) may be mounted in the small end bore 22. Each piston 12 may be coupled to the small end 21 by suitable means, such as a gudgeon pin, which is mounted in the small end bore 22. The connecting rod 18 may comprise an end cap 23, that may be attached by fixing means 24 to the connecting rod 18, such as bolts, to form a big end bore 25. A big end bearing (not shown) may be mounted in the big end bore 25.

The crankshaft 13 may include a plurality of main journals axially aligned along a longitudinal crankshaft axis X-X and mounted in main bearings. The crankshaft 13 may also include a plurality of rod journals 28 radially offset from the crankshaft axis X-X. Each of the rod journals 28 may be configured to be coupled to the big end 20 of a connecting rod 18. Various coupling mechanisms may be used to couple the big ends 20 of the connecting rods 18 to the rod journals 28. The crankshaft 27 may also include a plurality of webs 29. One or more of the webs 29 may be coupled between at least one of the main journals and one of the rod journals 28. Other components such as flywheels, dampers, counterweights etc. may be coupled to the crankshaft 13.

A plurality of block carriers 32 (also known as bearing holders) may be provided to mount the crankshaft 13 in the engine block 10 (see FIGS. 2, 3 and 5). The block carrier 32 may comprise a lower section 33 and an upper section 34. The lower section 33 may define a lower arcuate inner surface 35 and the upper section 34 may define an upper arcuate inner surface 36. The lower section 33 may be coupled to the upper section 34 by fixing means 37, such as bolts to clamp the main bearings between the lower arcuate inner surface 35 and the upper arcuate inner surface 36. The lower arcuate inner surface 35 and the upper arcuate inner surface 36 may together form an inner surface 35, 36 of the block carrier 32. The block carriers 32 and crankshaft 13 may form a crankshaft sub-assembly 38. The crankshaft sub-assembly 38 may be inserted into the cylinder block 10 and attached to the cylinder block 10 by suitable fixing means 39, such as bolts. The upper section 34 of the block carrier 32 may be provided with a projection 40, which may extend upwardly from the upper section 34. The projection 40 may have an upper surface 44, which is located against a lower end of the cylinder wall 41 when the crankshaft sub-assembly 38 is positioned in the engine block 10.

The block carriers 32 may be provided with a lubrication system, comprising a series of fluidly connected oil grooves 42 and oil channels 43, 46. An annular oil groove 42 may be provided in each of the lower arcuate inner surface 35 and the upper arcuate inner surface 36 of the block carriers 32, which fluidly communicate with each other when the lower section 33 and upper section 34 of the block carrier 32 are joined together (see FIG. 5).

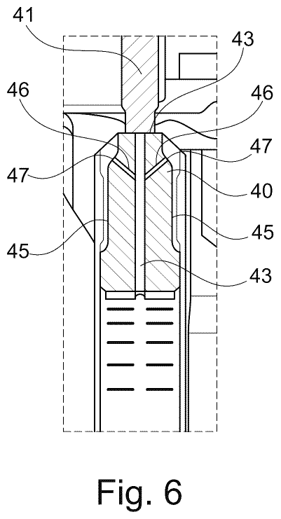

The projection 40 may be provided with at least one first oil channel 43 (see FIGS. 2 and 6), which may extend internally through the projection 40 from the upper arcuate inner surface 36 in the upper section 34 of the block carrier 32 towards the upper surface 44 of the projection 40, which may be in an upwardly vertical direction. The first oil channel 43 may extend partially into the body of the projection 40 or may extend all the way to the upper surface 44. The first oil channel 43 may be in fluid communication with the oil groove 42 in the upper arcuate inner surface 36. The first oil channel 43 may be formed, for example, by drilling.

The projection 40 may have opposing side surfaces 45, extending along its length from the upper surface 44. The projection 40 may be provided with at least one second oil channel 46, which may be an internal bore or channel, which may extend outwardly from the first oil channel 43 to the side surface 45 terminating in an outlet 47 in the side surface 45. The second oil channel 46 may be angled upwardly away from the first oil channel 43. The first and second oil channels 43, 46 may provide a lubrication flow path through the block carrier 32, in which lubricating oil may flow from the first oil channel 43 and through the second oil channel(s) 46. The lubricating oil exiting through the outlet 47 may form a jet which may be directed towards the small end 21 of the connecting rod 18 and the underside of the piston 12 when the piston is at bottom dead centre. The angle second oil channel 46 and location of the outlet 47 may be selected to optimise the direction of the jet. A pressure relief valve or a check valve may be installed at the outlet 47 to provide flow control.

The first and second oil channels 43, 46 may be formed by drilling, or another suitable method, and may have a circular cross section or may have another shaped cross section. The first and second oil channels 43, 46 may have different cross-sectional shapes. The diameter, or cross-sectional area, of the first oil channel 43 may be greater than that of the second oil channel 46. The diameter, or cross section area, of the first and second oil channels 43, 46 may be selected to optimise the flow of lubricating oil according to the parameters (such as size and power) of the engine 5.

The first and second oil channels 43, 46 may be straight, or they may be curved.

In one example, each of the block carriers 32 in the engine 5 may be provided with a first oil channel 43 and two second oil channels 46, one extending to each side surface 45 of the projection 40. In another example, each of the block carriers 32 in the engine 5 may be provided with a first oil channel 43 and a single second oil channel 46, extending to only one side surface 45 of the projection 40. Alternatively, not all of the block carriers 32 in the engine 5 may be provided with first and second oil channels 43, 46.

### INDUSTRIAL APPLICABILITY

The engine 5 may be assembled for use by assembling the crankshaft sub-assembly 38, with a desired number of block carriers 32 with the desired configuration of lubrication system, inserting the crankshaft sub-assembly 38 into the engine block 10 and securing it in position.

During operation of the engine 5, the crankshaft 13 may be driven to rotate by the reciprocating action of the piston(s) 12 between top and bottom dead centre. An oil pump, which may be driven by the crankshaft 13, may supply lubricating oil to the components in the engine block 10. The oil pump may supply lubricating oil to the rotating crankshaft 13 and the main bearings 13 as the crankshaft 13 rotates in the main bearings, by means of a series of oil channels. Lubricating oil from the main bearings may flow through any block carrier 32 which may be provided with first and second oil channels 43, 46 as described above, which form a lubrication system. The lubricating oil may flow from the main bearings into and through the oil grooves 42 in the inner surface of the block carrier 32, into the first oil channel 43 and into the second oil channel(s) 46, to provide a jet of lubricating oil from the outlet(s) 47 which may be directed towards the small end 21 of an adjacent connecting rod 18 and the underside of the piston 12 connected to the adjacent connecting rod 18 when the piston 12 is at bottom dead centre.

1. A block carrier for mounting a crankshaft in an engine block comprising:
an inner surface configured to receive a crankshaft main bearing and provided with at least one oil groove; and
a projection, said projection having:
at least one side surface;
at least one first oil channel in fluid communication with the with the at least one oil groove and extending internally through the projection from the inner surface;
at least one second oil channel in fluid communication with the at least one first oil channel and extending internally from the at least one first oil channel to the at least one side surface terminating in an outlet in the at least one side surface.

2. The block carrier as claimed in claim 1, wherein the projection has an upper surface and the at least one first oil channel extends from the inner surface to the upper surface.

3. The block carrier as claimed in claim 1, wherein the at least one first oil channel extends vertically through the projection.

4. The block carrier as claimed in claim 1, in which the at least one second oil channel extends at an angle upwardly away from the at least one first oil channel.

5. The block carrier as claimed in claim 1, in which the projection has two opposing side surfaces and second oil channels extending from the at least one first oil channel to each of the two opposing side surfaces.

6. The block carrier as claimed in claim 1, in which a diameter or cross section area of the at least one second oil channel is smaller than that of the at least one first oil channel.

7. An internal combustion engine, comprising:
an engine block having at least one cylinder in which is reciprocally mounted a piston;
at least one block carrier as claimed in any one of the preceding claims;
a crankshaft having a plurality of main journals on which are mounted in main bearings, said main bearings being mounted in the at least one block carrier;
at least one connecting rod having a small end attached to the piston and a big end attached to the crankshaft; and
means of supplying lubricating oil to the main bearings.

8. The block carrier as claimed in claim 2, wherein the at least one first oil channel extends vertically through the projection.

9. The block carrier as claimed in claim 2, in which the at least one second oil channel extends at an angle upwardly away from the at least one first oil channel.

10. The block carrier as claimed in claim 2, in which the projection has two opposing side surfaces and second oil channels extending from the at least one first oil channel to each of the two opposing side surfaces.

11. The block carrier as claimed in claim 2, in which a diameter or cross section area of the at least one second oil channel is smaller than that of the at least one first oil channel.

12. The block carrier as claimed in claim 3, in which the at least one second oil channel extends at an angle upwardly away from the at least one first oil channel.

13. The block carrier as claimed in claim 3, in which the projection has two opposing side surfaces and second oil channels extending from the at least one first oil channel to each of the two opposing side surfaces.

14. The block carrier as claimed in claim 3, in which a diameter or cross section area of the at least one second oil channel is smaller than that of the at least one first oil channel.

15. The block carrier as claimed in claim 4, in which the projection has two opposing side surfaces and second oil channels extending from the at least one first oil channel to each of the two opposing side surfaces.

16. The block carrier as claimed in claim 4, in which a diameter or cross section area of the at least one second oil channel is smaller than that of the at least one first oil channel.

17. The block carrier as claimed in claim 5, in which a diameter or cross section area of the at least one second oil channel is smaller than that of the at least one first oil channel.
